(19) United States
(12) Patent Application Publication
(10) Pub. No.: US 2025/0391436 A1
(43) Pub. Date: Dec. 25, 2025

(54) MAGNETIC RECORDING MEDIUM, AND MAGNETIC RECORDING AND REPRODUCING DEVICE

(71) Applicant: Resonac Hard Disk Corporation, Chiba (JP)

(72) Inventors: Yudai TAKAHASHI, Chiba (JP); Haruhisa OHASHI, Chiba (JP)

(21) Appl. No.: 19/244,052

(22) Filed: Jun. 20, 2025

(30) Foreign Application Priority Data
Jun. 24, 2024 (JP) 2024-101081

(51) Int. Cl. G11B 5/73

(52) U.S. Cl. CPC G11B 5/73

(57) ABSTRACT

A magnetic recording medium includes a nonmagnetic substrate; a base layer over the nonmagnetic substrate; a seed layer over the base layer; and a magnetic recording layer over the seed layer. The seed layer includes two elements that are phase-separated from each other. A phase of one element of the two elements, represented by element α, mainly includes a columnar crystal having an fcc structure. A phase of another element of the two elements, represented by element β, mainly includes an amorphous structure. The base layer includes, in sequence from the nonmagnetic substrate, first, second, and third base layers. The first base layer mainly includes Ru, Cr, or Ni. The second base layer mainly includes the element α. The third base layer mainly includes Ru, Cr, or Mo.

### CROSS-REFERENCE TO RELATED APPLICATIONS

The present application is based on and claims priority to Japanese Patent Application No. 2024-101081 filed on Jun. 24, 2024, the entire contents of which are hereby incorporated by reference.

### BACKGROUND

### 1. Field of the Invention

The present disclosure relates to a magnetic recording medium, and a magnetic recording and reproducing device.

### 2. Description of the Related Art

In hard disk drives (HDDs), which are one type of magnetic recording and reproducing devices, development of a magnetic recording medium suitable for higher recording density has been progressing. Magnetic recording and reproducing devices currently available on the market include, as a magnetic recording medium, what is referred to as a perpendicular magnetic recording medium in which the axis of easy magnetization in a magnetic film is perpendicularly oriented. Even if the perpendicular magnetic recording medium is formed to have a higher recording density, the perpendicular magnetic recording medium has a small impact of a demagnetization field in a boundary region between recording bits and forms clear bit boundaries, and thus an increase in noise is suppressed. Also, the perpendicular magnetic recording medium has excellent thermal fluctuation characteristics because of suppression of reduction in the recording bit volume due to an increased recording density.

As such a perpendicular magnetic recording medium, for example, Japanese Laid-Open Patent Application No. 2013-196752 discloses a perpendicular magnetic recording medium including: a nonmagnetic orientation control layer including, as a main component, at least one element selected from the group consisting of silver, palladium, and ruthenium; a nonmagnetic seed layer including silver particles having an fcc structure, and an amorphous germanium grain boundary; a nonmagnetic intermediate layer of a ruthenium alloy; and a perpendicular magnetic recording layer of cobalt, iron, and platinum, the nonmagnetic orientation control layer, the nonmagnetic seed layer, the nonmagnetic intermediate layer, and the perpendicular magnetic recording layer being stacked in this order, one on top of the other.

### SUMMARY

The present disclosure provides the following.
[1] A magnetic recording medium, including:
a nonmagnetic substrate;
a base layer over the nonmagnetic substrate;
a seed layer over the base layer; and
a magnetic recording layer over the seed layer, wherein
the seed layer includes two elements that are phase-separated from each other,
a phase of one element of the two elements, represented by element α, mainly includes a columnar crystal having an fcc structure,
a phase of another element of the two elements, represented by element β, mainly includes an amorphous structure,
the base layer includes, in sequence from the nonmagnetic substrate, a first base layer, a second base layer, and a third base layer,
the first base layer mainly includes Ru, Cr, or Ni,
the second base layer mainly includes the element α, and
the third base layer mainly includes Ru, Cr, or

Mo.
[2] The magnetic recording medium according to [1], wherein
the element α is Ag, Au, Al, or Pd, and
the element β is Ge or Si.
[3] The magnetic recording medium according to
[1] or [2], further including:
an intermediate layer between the seed layer and the magnetic recording layer, wherein
the intermediate layer is a layer that mainly includes Ru, and
the magnetic recording layer is a layer that mainly includes Co, Cr, and Pt.
[4] The magnetic recording medium according to any one of [1] to [3], further including:
an intermediate layer between the seed layer and the magnetic recording layer, wherein
the intermediate layer is a layer that mainly includes an NaCl-type compound, and
the magnetic recording layer is a layer that mainly includes a magnetic particle having an L1₀ structure.
[5] A magnetic recording and reproducing device, including:
the magnetic recording medium of any one of [1] to [4].

### BRIEF DESCRIPTION OF THE DRAWINGS

FIG. 1 is a cross-sectional view illustrating an example of a configuration of a magnetic recording medium according to an embodiment of the present disclosure; and

FIG. 2 is a perspective view illustrating an example of a magnetic recording and reproducing device in which the magnetic recording medium according to the embodiment of the present disclosure is applied.

### DETAILED DESCRIPTION OF THE DISCLOSURE

Requirements for higher recording density of magnetic recording media are ever increasing, and a further improvement in characteristics is required for magnetic recording media. Specifically, for increasing the recording density of a magnetic recording medium, there is a need to further micronize magnetic particles forming a magnetic recording layer, and enhance perpendicular orientation of the magnetic particles.

The present disclosure has been made in view of such issues, and thus provides: a magnetic recording medium in which the perpendicular orientation of the magnetic recording layer is enhanced to enable a further increase in the recording density; and a magnetic recording and reproducing device including such a magnetic recording medium.

Hereinafter, a magnetic recording medium and a magnetic recording and reproducing device according to embodiments of the present disclosure will be described in detail with reference to the drawings. In the drawings referred to in the following description, characteristic parts may be enlarged for the sake of convenience for ease of understanding of the features of the embodiments. Thus, dimensional proportions of components are not necessarily the same as in reality. In the present specification, “to” indicating a numerical range means that the numerical values described before and after “to” are included as the lower limit and the upper limit, unless otherwise specified. In the numerical range represented by “to”, when only the upper limit is indicated in units, the lower limit is indicated in the same units.

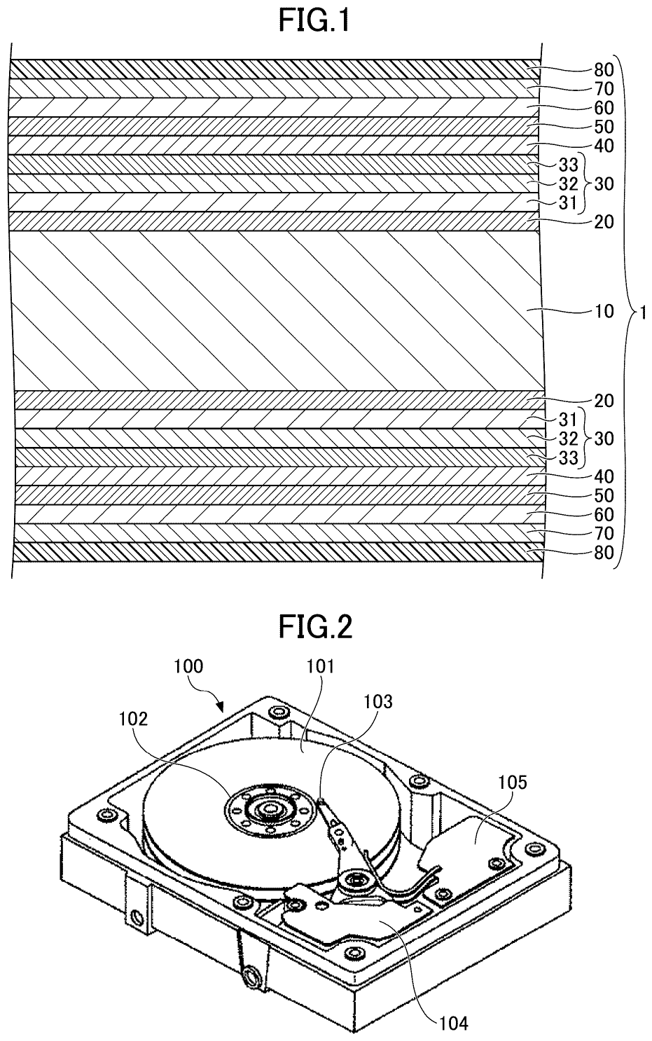

FIG. 1 is a cross-sectional view illustrating an example of a configuration of a magnetic recording medium according to the present embodiment. As illustrated in FIG. 1, a magnetic recording medium 1 according to the present embodiment includes a nonmagnetic substrate 10, soft magnetic backing layers 20, base layers 30, seed layers 40, intermediate layers 50, magnetic recording layers 60, protective layers 70, and lubricating layers 80 that are sequentially stacked over both surfaces of the nonmagnetic substrate 10.

The magnetic recording medium 1 is a magnetic recording medium including the base layers 30, the seed layers 40, and the magnetic recording layers 60 that are sequentially stacked over the nonmagnetic substrate 10.

The seed layers 40 include two elements that are phase-separated from each other. The phase of one element of the two elements, represented by element α, mainly includes a columnar crystal having an fcc structure, and the phase of the other element of the two elements, represented by element β, mainly includes an amorphous structure. The base layer 30 includes, in sequence from the nonmagnetic substrate 10, a first base layer 31, a second base layer 32, and a third base layer 33. The first base layer 31 mainly includes Ru, Cr, or Ni, the second base layer 32 mainly includes the element α, and the third base layer 33 mainly includes Ru, Cr, or Mo.

According to the magnetic recording medium 1 having such a structure, it is possible to micronize the crystal particles forming the seed layer 40, and enhance orientation of the crystal particles. Thus, columnar crystals from the intermediate layer 50 to the magnetic recording layer 60 can be formed finely and with high orientation based on the seed layer 40 serving as an origin. By promoting micronization and magnetic isolation of the magnetic particles included in the magnetic recording layer 60 of the magnetic recording medium 1, it is possible to enhance perpendicular orientation of the magnetic recording layer 60, enabling an increased recording density. Therefore, the magnetic recording medium 1 can greatly improve the signal/noise ratio (S/N ratio) at the time of reproducing and also improve the thermal fluctuation characteristics, and thus exhibit more excellent recording characteristics, e.g., overwrite characteristics (OW).

The seed layer 40 is preferably formed using a eutectic alloy in which the element α and the element β are phase-separated. In the case of such a eutectic alloy, the phase of the element α tends to form fine crystals having uniform particle sizes, and the phase of the element β tends to enclose the element α to form a uniform granular structure.

The element α of the seed layer 40 is preferably Ag (having an fcc structure), Au (having an fcc structure), Al (having an fcc structure), or Pd (having an fcc structure), and the element β of the seed layer 40 is preferably Ge or Si. By using such elements as the element α and the element β, an alloy forming the seed layer 40 becomes a eutectic alloy, in which the phase of the element α is a fine columnar crystal having an fcc structure and a uniform particle size, and the phase of the element β becomes an amorphous structure. Therefore, the seed layer 40 tends to have a granular structure including the columnar crystal of the element α, and the element β having the amorphous structure and enclosing the columnar crystal of the element α. It is particularly preferable to use AgGe, AgSi, AlGe, AuGe, or AlSi as the alloy forming the seed layer 40.

As long as the above structure can be maintained, the layer thickness of the seed layer 40 is preferably as small as possible, and is, for example, 100 nm or less.

The base layer 30 has the effect of enhancing the crystal orientation of the seed layer 40 formed over the base layer 30. Specifically, when the columnar crystal of the element α included in the seed layer 40 has an fcc structure, the base layer 30 has the effect of enhancing the orientation of the (111) plane or the orientation of the (200) plane.

The first base layer 31 is a layer that mainly includes Ru, Cr, or Ni, and serves as an origin of crystal orientation. When the columnar crystal of the element α included in the seed layer 40 has an fcc structure, the first base layer 31 can enhance the orientation of the (111) plane or the orientation of the (200) plane.

The description “mainly includes Ru, Cr, or Ni” includes a case in which the most abundant element forming the first base layer 31 is Ru, Cr, or Ni, and preferably the content of Ru, Cr, or Ni is 50 atomic % or more of the elements forming the first base layer 31, and also includes a case in which the content of Ru, Cr, or Ni is 100 atomic % of the elements forming the first base layer 31.

The layer thickness of the first base layer 31 is preferably in the range of 1 nm to 10 nm.

The second base layer 32 mainly includes the element α included in the seed layer 40. By causing the second base layer 32 to have a crystal orientation the same as the crystal orientation of the seed layer 40, when the columnar crystal of the element α included in the seed layer 40 has an fcc structure, the second base layer 32 can enhance the orientation of the (111) plane or the orientation of the (200) plane.

The description “mainly includes the element α” includes a case in which the most abundant element forming the second base layer 32 is the element α, and preferably the content of the element α is 50 atomic % or more of the elements forming the second base layer 32, and also includes a case in which the content of the element α is 100 atomic % of the elements forming the second base layer 32.

The layer thickness of the second base layer 32 is preferably in the range of 1 nm to 10 nm.

The third base layer 33 is a layer that mainly includes Ru, Cr, or Mo, and is preferentially alloyed with the element β at the interface with the seed layer 40. This promotes phase separation between the element α0 and the element β. When the columnar crystal of the element α included in the seed layer 40 has an fcc structure, the third base layer 33 can enhance the orientation of the (111) plane or the orientation of the (200) plane. Also, the third base layer 33 has the effect of suppressing unintended diffusion of the elements from the layers on the nonmagnetic substrate 10 side to the seed layer 40.

The description “mainly includes Ru, Cr, or Mo” includes a case in which the most abundant element forming the third base layer 33 is Ru, Cr, or Mo, and preferably the content of Ru, Cr, or Mo is 50 atomic % or more of the elements forming the third base layer 33, and also includes a case in which the content of Ru, Cr, or Mo is 100 atomic % of the elements forming the third base layer 33.

The layer thickness of the third base layer 33 is preferably in the range of 1 nm to 10 nm.

The magnetic recording medium 1 includes the intermediate layer 50 between the seed layer 40 and the magnetic recording layer 60. The intermediate layer 50 is preferably a layer that mainly includes Ru or MgO, and the magnetic recording layer 60 is preferably a layer that mainly includes a Co—Cr—Pt-based alloy including Co, Cr, and Pt.

The description “mainly includes Ru or MgO” includes a case in which the most abundant element forming the intermediate layer 50 is Ru or MgO, and preferably the content of Ru or MgO is preferably 50 atomic % or more of the elements forming the intermediate layer 50, and also includes a case in which the content of Ru or MgO is 100% of the elements forming the intermediate layer 50.

When the intermediate layer 50 that mainly includes Ru or MgO is formed over the seed layer 40, crystal particles forming the intermediate layer 50 become columnar crystals continuous in the thickness direction, and grow epitaxially while corresponding to the crystal particles of the seed layer 40 at 1:1. When the magnetic recording layer 60 is formed over the intermediate layer 50, crystal particles forming the magnetic recording layer 60 become columnar crystals continuous in the thickness direction, and grow epitaxially while corresponding to the crystal particles of the intermediate layer 50 at 1:1.

In particular, the columnar crystals grown epitaxially become more uniform when the crystal particles of the element α forming the seed layer 40 are Ag, Au, Al, or Pd having a (111) or (200)-oriented fcc structure, the intermediate layer 50 is Ru or MgO having a (200)-oriented hcp structure, and the magnetic recording layer 60 is a Co—Cr—Pt-based alloy having a (002)-oriented hcp structure.

The magnetic recording layer 60 includes a Co—Cr—Pt-based alloy as a main component, and may further include an oxide. The oxide is preferably an oxide of Cr, Si, Ta, Al, Ti, Mg, Co, B, or the like. In particular, TiO₂, Cr₂O₃, SiO₂, B₂O₃, or the like is suitable. Also, the magnetic recording layer 60 is preferably a composite oxide including two or more different oxides. In particular, Cr₂O₃—SiO₂, Cr₂O₃—TiO₂, Cr₂O₃—SiO₂—TiO₂, or the like is suitable.

The thickness of the magnetic recording layer 60 is preferably 5 nm to 20 nm. When the thickness of the magnetic recording layer 60 is 5 nm or more, sufficient reproduction outputs can be obtained, and degradation in thermal fluctuation characteristics can be suppressed. The thickness of the magnetic recording layer 60 is preferably 20 nm or less because at such a thickness, enlargement of magnetic particles in the magnetic recording layer 60 is suppressed, noise during recording and reproduction is reduced, and degradation in recording and reproducing characteristics represented by an S/N ratio and recording characteristics, e.g., overwrite characteristics (OW) is suppressed. The magnetic recording layer 60 may be a

multilayer structure of the magnetic recording layers 60. A nonmagnetic layer may be provided between the magnetic recording layers 60 of the multilayer structure. As the nonmagnetic layer provided between the magnetic recording layers 60, a material having an hcp structure is preferably used. For example, it is suitable to use Ru, Ru alloys, CoCr alloys, CoCrX1 alloys (X1 represents one or more elements selected from Pt, Ta, Zr, Re, Ru, Cu, Nb, Ni, Mn, Ge, Si, O, N, W, Mo, Ti, V, Zr, and B), or the like.

The magnetic recording medium 1 is preferably such that the intermediate layer 50 is provided between the seed layer 40 and the magnetic recording layer 60, the intermediate layer 50 mainly includes an NaCl-type compound, and the magnetic recording layer 60 mainly includes magnetic particles having an L1₀ structure.

The description “mainly includes an NaCl-type compound” includes a case in which the most abundant element forming the intermediate layer 50 is the NaCl-type compound, and preferably the content of the NaCl-type compound is 50 atomic % or more of the elements forming the intermediate layer 50, and also includes a case in which the content of the NaCl-type compound is 100% of the elements forming the intermediate layer 50.

The description “mainly includes magnetic particles having an L1₀ structure” includes a case in which the most abundant element forming the magnetic recording layer 60 is the magnetic particles having the L1₀ structure, and preferably the content of the magnetic particles having the L1₀ structure is 50 atomic % or more of the magnetic particles forming the magnetic recording layer 60, and also includes a case in which the content of the magnetic particles having the L1₀ structure is 100% of the magnetic particles forming the magnetic recording layer 60.

Examples of the magnetic particles having the L1₀ structure include FePt alloy particles, CoPt alloy particles, and the like. Examples of the NaCl-type compound include MgO, TiO, Nio, TiN, TaN, HfN, NbN, ZrC, HfC, TaC, Nbc, TiC, and the like. These may be used alone or in combination.

When the intermediate layer 50 that mainly includes the NaCl-type compound is formed over the seed layer 40, crystal particles forming the intermediate layer 50 become columnar crystals continuous in the thickness direction, and grow epitaxially while corresponding to the crystal particles of the seed layer 40 at 1:1. When the magnetic recording layer 60 is formed over the intermediate layer 50, crystal particles forming the magnetic recording layer 60 become columnar crystals continuous in the thickness direction, and grow epitaxially while corresponding to the crystal particles of the intermediate layer 50 at 1:1.

In particular, the columnar crystals grown epitaxially become more uniform when the first base layer 31 of the base layer 30 mainly includes Ni having a (111)-oriented fcc structure, the crystal particles of the element α forming the seed layer 40 are Ag, Au, Al, or Pd having a (111)-oriented fcc structure, the intermediate layer 50 is Ru having a (200)-oriented structure, and the magnetic recording layer 60 is an FePt alloy having a (001)-oriented L1₀ structure. Alternatively, the columnar crystals grown epitaxially become more uniform when the first base layer 31 of the base layer 30 mainly includes Cr having a (200)-oriented fcc structure, the crystal particles of the element α forming the seed layer 40 are Ag, Au, Al, or Pd having a (200)-oriented fcc structure, the intermediate layer 50 is a (200)-oriented MgO, which is an NaCl-type compound, and the magnetic recording layer 60 is an FePt alloy having a (001)-oriented L1₀ structure. As the element α, Ag is particularly preferable.

At least one element selected from the group consisting of Al, Si, Ga, and Ge may be added to the magnetic particles having the L1₀ structure. The amount of the at least one element added is preferably 2% by mol to 20% by mol, and more preferably 2.5% by mol to 10% by mol. When the at least one element is added in the above amount, the orientation of the (001) plane of the magnetic recording layer 60 is improved.

Also, the magnetic recording layer 60 may be formed into a granular structure by addition of a grain boundary segregation material to the magnetic recording layer 60. This improves the orientation of the (001) plane of the magnetic recording layer 60. Examples of the grain boundary segregation material include, for example, nitrides, such as VN, BN, SiN, TiN, and the like, carbides, such as C, VC, and the like, and borides, such as BN and the like. These may be used alone or in combination.

The thickness of the magnetic recording layer 60 is preferably 5 nm to 20 nm. When the thickness of the magnetic recording layer 60 is 5 nm or more, sufficient reproduction outputs can be obtained, and degradation in thermal fluctuation characteristics can be suppressed. The thickness of the magnetic recording layer 60 is preferably 20 nm or less because at such a thickness, enlargement of magnetic particles in the magnetic recording layer 60 is suppressed and noise during recording and reproduction is reduced. This is also because recording and reproducing characteristics represented by an S/N ratio and recording characteristics, e.g., overwrite characteristics (OW) can be successfully maintained.

The magnetic recording layer 60 may be a multilayer structure of the magnetic recording layers 60. A nonmagnetic layer may be provided between the magnetic recording layers 60 of the multilayer structure.

The other configurations will be described.

The nonmagnetic substrate 10 may be a metal substrate formed of a metal material, such as aluminum, an aluminum alloy, or the like. Alternatively, the nonmagnetic substrate 10 may be a nonmetal substrate formed of a nonmetal material, such as glass, ceramics, silicon, silicon carbide, carbon, or the like. Also, it is possible to use the metal substrate or nonmetal substrate including, over its surface, a NiP layer or NiP alloy layer that is formed through plating, sputtering, or the like.

The soft magnetic backing layer 20 is provided to increase a component of a magnetic flux generated from a magnetic head that is perpendicular to the substrate surface of the nonmagnetic substrate 10, and more firmly fix the direction of magnetization of the magnetic recording layer 60, in which information is to be recorded, in a direction perpendicular to the nonmagnetic substrate 10. This effect becomes more significant especially when a magnetic monopole head for perpendicular recording is used as the magnetic head for recording and reproduction.

As the soft magnetic backing layer 20, it is possible to use a soft magnetic material having an amorphous or microcrystalline structure including Fe and other elements, such as Ni, Co, and the like. Examples of the soft magnetic material include CoFe-based alloys (e.g., CoFeTaZr, CoFeZrNb, and the like), FeCo-based alloys (e.g., FeCo, FeCoV, and the like), FeNi-based alloys (e.g., FeNi, FeNiMo, FeNiCr, FeNiSi, and the like), FeAl-based alloys (e.g., FeAl, FeAlSi, FeAlSiCr, FeAlSiTiRu, FeAlO, and the like), FeCr-based alloys (e.g., FeCr, FeCrTi, FeCrCu, and the like), FeTa-based alloys (e.g., FeTa, FeTaC, FeTaN, and the like), FeMg-based alloys (e.g., FeMgO and the like), FeZr-based alloys (e.g., FeZrN and the like), FeC-based alloys, FeN-based alloys, FeSi-based alloys, FeP-based alloys, FeNb-based alloys, FeHf-based alloys, FeB-based alloys, and the like.

The soft magnetic backing layer 20 includes two soft magnetic films, and a Ru film is preferably provided between the two soft magnetic films. By adjusting the thickness of the Ru film to be in the range of 0.4 nm to 1.0 nm or in the range of 1.6 nm to 2.6 nm, the two soft magnetic films become an AFC structure. The soft magnetic backing layer 20 having the AFC structure can suppress what is referred to as spike noise.

The protective layer 70 suppresses corrosion of the magnetic recording layer 60. Also, the protective layer 70 suppresses damage to the surface of the magnetic recording medium 1 when the magnetic head contacts the magnetic recording medium 1. The protective layer 70 can be formed using a material typically used as a protective layer, e.g., using a material including C.

The thickness of the protective layer 70 is preferably 1 nm to 10 nm in terms of reducing the distance between the head and the magnetic recording medium 1 and in terms of achieving an increased recording density of the magnetic recording medium 1.

The lubricating layer 80 is preferably formed using a lubricant, such as perfluoropolyether, fluorinated alcohol, fluorinated carboxylic acid, or the like.

### Magnetic Recording and Reproducing Device

A magnetic recording and reproducing device including the

magnetic recording medium according to the present embodiment will be described. No particular limitation is imposed on the form of the magnetic recording and reproducing device according to the present embodiment, as long as the magnetic recording and reproducing device includes the magnetic recording medium according to the present embodiment.

FIG. 2 is a perspective view illustrating an example of the magnetic recording and reproducing device in which the magnetic recording medium according to the present embodiment is applied. As illustrated in FIG. 2, the magnetic recording and reproducing device 100 includes a perpendicular magnetic recording medium 101, a medium driver 102 configured to rotate the perpendicular magnetic recording medium 101, a magnetic head 103 configured to record and reproduce information with respect to the perpendicular magnetic recording medium 101, a head driver 104 configured to move the magnetic head 103 relative to the perpendicular magnetic recording medium 101, and a recording and reproducing signal processing system 105. The perpendicular magnetic recording medium 101 is the magnetic recording medium 1 illustrated in FIG. 1. The recording and reproducing signal processing system 105 is configured to process data input from the exterior and transmit a recording signal to the magnetic head 103, and process a reproducing signal from the magnetic head 103 and transmit data to the exterior.

According to the magnetic recording and reproducing device 100, the magnetic recording medium 1 can exhibit more excellent recording characteristics, e.g., overwrite characteristics (OW). Thus, the magnetic recording and reproducing device 100 can exhibit excellent high-density recording.

Although the embodiments of the present invention have been described above, the above embodiments are presented just as examples, and the present invention is not limited to the above embodiments. The above embodiments can be implemented in various other forms, and various combinations, omissions, substitutions, modifications, and the like are possible without departing from the intent of the present invention. These embodiments and modifications thereof are included in the scope and intent of the present invention, and are also included in the scope of the inventions recited in claims and in the scope of equivalents thereof.

### EXAMPLES

Hereinafter, the present embodiment will be described in more detail by way of examples, but the present embodiment is not limited to the examples.

### Example 1

In Example 1, a cleaned glass substrate (outer profile: 3.5 inches (about 8.89 cm), obtained from HOYA Corporation) was provided as a nonmagnetic substrate. The provided glass substrate was housed in a chamber of a film-forming apparatus (C-3010, obtained from ANELVA Corporation). The interior of the chamber for film formation was evacuated under reduced pressure until the highest reachable degree of vacuum, i.e., 1×10⁻⁵ Pa. Subsequently, an adhesion layer having a layer thickness of 10 nm was formed over the glass substrate through DC magnetron sputtering using a Cr target. After the substrate temperature was reduced to 100° C. or lower, a soft magnetic backing layer having a layer thickness of 25 nm was formed over the adhesion layer through DC magnetron sputtering using a target of Co-2OFe-5Zr-5Ta {Fe content: 20 atomic %, Zr content: 5 atomic %, Ta content: 5 atomic %, and balance: Co}. A Ru layer having a layer thickness of 0.7 nm was formed over the soft magnetic backing layer through DC magnetron sputtering. Subsequently, a soft magnetic backing layer having a layer thickness of 25 nm was formed again through DC magnetron sputtering using the target of Co-2OFe-5Zr-5Ta.

Next, a first base layer having a layer thickness of 5 nm was formed over the soft magnetic backing layer through DC magnetron sputtering using a target of 82Ni-3W-15Fe {W content: 3 atomic %, Fe content: 15 atomic %, and balance: Ni}.

Next, a second base layer having a layer thickness of 2 nm was formed over the first base layer through DC magnetron sputtering using an Ag target.

Next, a third base layer having a layer thickness of 0.3 nm was formed over the second base layer through DC magnetron sputtering using a Ru target.

Next, a seed layer having a layer thickness of 5 nm was formed over the third base layer through RF sputtering using a target of 40Ag-60Ge.

Next, an intermediate layer having a layer thickness of 20 nm was formed using a Ru target. In the formation of the intermediate layer, a Ru layer having a layer thickness of 10 nm was formed at a sputtering pressure of 0.8 Pa, and then a Ru layer having a layer thickness of 10 nm was formed at a sputtering pressure of 1.5 Pa.

Next, a three-layered magnetic recording layer was formed over the intermediate layer through DC magnetron sputtering. That is, a first magnetic recording layer having a layer thickness of 9 nm was formed using a target of 91 (Co15Cr16Pt)-6(SiO₂)-3(TiO₂) {Cr content: 15 atomic %, Pt content: 16 atomic %, and balance: 91% by mol of a Co alloy, 6% by mol of an oxide of SiO₂, and 3% by mol of an oxide of TiO₂}. The sputtering pressure at this time was set to 2 Pa.

Next, a second magnetic recording layer having a layer thickness of 6 nm was formed over the first magnetic recording layer using a target of 92(Co11Cr18Pt)-5(SiO₂)-3(TiO₂) {Cr content: 11 atomic %, Pt content: 18 atomic %, and balance: 92% by mol of a Co alloy, 5% by mol of an oxide of SiO_{2,} and 3% by mol of an oxide of TiO₂}. The sputtering pressure at this time was set to 2 Pa.

Next, a third magnetic recording layer having a layer thickness of 7 nm was formed over the second magnetic recording layer using a target of Co20Cr14Pt3B {Cr content: 20 atomic %, Pt content: 14 atomic %, B content: 3 atomic %, and balance: Co}. The sputtering pressure at this time was set to 0.6 Pa.

Next, a protective layer having a layer thickness of 3 nm was formed over the third magnetic recording layer through CVD. Subsequently, a lubricating film of perfluoropolyether was formed to have a thickness of 1 nm through dipping, thereby producing a magnetic recording medium of Example 1. The configuration of each layer of the produced magnetic recording medium is shown in Tables 1-1 and 1-2, Tables 2-1 and 2-2, and Tables 3-1 and 3-2.

The produced magnetic recording medium was observed under a TEM to measure average particle sizes D of magnetic particles forming the first to third magnetic recording layers, and particle size dispersions normalized by the average particle sizes D, i.e., σ/D. Also, the intermediate layer was evaluated for a c-axis orientation dispersion (Δθ50) through X-ray diffraction. The Δθ50 was measured at a diffraction peak of the (002) plane both when the intermediate layer was formed of Ru and when the intermediate layer was formed of MgO. The evaluation results are shown in Tables 2-1 and 2-2 and Tables 3-1 and 3-2. Smaller values of the average particle size D, the particle size dispersion σ/D, and the c-axis orientation dispersion Δθ50 mean that the magnetic particles were micronized and higher degrees of orientation were obtained.

### Examples 2 to 11 and Comparative Examples 1 to 7

Magnetic recording media were produced in the same manner as in Example 1, except that the production conditions of the first to third base layers, the seed layer, the intermediate layer, and the magnetic recording layer were changed as shown in Tables 1-1 and 1-2, Tables 2-1 and 2-2, and Tables 3-1 and 3-2. In Example 6, the substrate temperature was set to 250° C. in the formation of the intermediate layer of MgO, and the substrate temperature was set to 450° C. in the formation of the magnetic recording layer of FePt. The evaluation results are shown in Tables 2-1 and 2-2 and Tables 3-1 and 3-2.

TABLE 1-1

| | First base layer | | Second base layer | | Third base layer | |
|---|---|---|---|---|---|---|
| | | Thick- | | Thick- | | Thick- |
| | Composition | ness | Composition | ness | Composition | ness |
| | [atomic %] | [nm] | [atomic %] | [nm] | [atomic %] | [nm] |
| Example 1 | 82Ni—3W—15Fe | 5 | Ag | 2 | Ru | 0.3 |
| Example 2 | 82Ni—3W—15Fe | 5 | Ag | 5 | Ru | 0.3 |
| Example 3 | 82Ni—3W—15Fe | 5 | Al | 5 | Ru | 0.3 |
| Example 4 | 82Ni—3W—15Fe | 5 | Au | 5 | Ru | 0.3 |
| Example 5 | 82Ni—3W—15Fe | 5 | Al | 5 | Ru | 0.3 |
| Example 6 | Cr | 10 | Ag | 10 | Ru | 0.3 |
| Example 7 | Ru | 10 | Ag | 2 | Ru | 0.3 |
| Example 8 | 82Ni—3W—15Fe | 5 | Ag | 2 | Ru | 0.3 |
| Example 9 | 82Ni—3W—15Fe | 5 | Ag | 2 | Cr | 0.5 |
| Example 10 | 82Ni—3W—15Fe | 5 | Ag | 2 | Mo | 0.5 |
| Example 11 | 82Ni—3W—15Fe | 5 | Ag | 2 | Ru | 0.3 |

TABLE 1-2

| | First base layer | | Second base layer | | Third base layer | |
|---|---|---|---|---|---|---|
| | | Thick- | | Thick- | | Thick- |
| | Composition | ness | Composition | ness | Composition | ness |
| | [atomic %] | [nm] | [atomic %] | [nm] | [atomic %] | [nm] |
| Comparative | 82Ni—3W—15Fe | 5 | Ag | 2 | — | — |
| Example 1 | | | | | | |
| Comparative | 82Ni—3W—15Fe | 5 | — | — | Ru | 0.3 |
| Example 2 | | | | | | |
| Comparative | — | — | Ag | 2 | Ru | 0.3 |
| Example 3 | | | | | | |
| Comparative | — | — | Ag | 2 | — | — |
| Example 4 | | | | | | |
| Comparative | 82Ni—3W—15Fe | 5 | — | — | — | — |
| Example 5 | | | | | | |
| Comparative | — | — | — | — | Ru | 0.3 |
| Example 6 | | | | | | |
| Comparative | Cr | 10 | Ag | 10 | — | — |
| Example 7 | | | | | | |

TABLE 2-1

| | Seed layer | | | Intermediate | |
|---|---|---|---|---|---|
| | | Thick- | | layer | |
| | Composition | ness | | Compo- | |
| | [atomic %] | [nm] | Structure | sition | Δθ50 |
| Example 1 | 40Ag—60Ge | 5 | Ag: columnar | Ru | 3.2 |
| | | | crystal (fcc), | | |
| | | | Ge: amorphous | | |
| | | | structure | | |
| Example 2 | 50Ag—50Si | 10 | Ag: columnar | Ru | 3.6 |
| | | | crystal (fcc), | | |
| | | | Si: amorphous | | |
| | | | structure | | |
| Example 3 | 50Al—50Ge | 10 | Al: columnar | Ru | 3.3 |
| | | | crystal (fcc), | | |
| | | | Ge: amorphous | | |
| | | | structure | | |
| Example 4 | 50Au—50Ge | 10 | Au: columnar | Ru | 3.2 |
| | | | crystal (fcc), | | |
| | | | Ge: amorphous | | |
| | | | structure | | |
| Example 5 | 40Al—60Si | 10 | Al: columnar | Ru | 3.5 |
| | | | crystal (fcc), | | |
| | | | Si: amorphous | | |
| | | | structure | | |
| Example 6 | 40Ag—60Si | 10 | Ag: columnar | MgO | 5.1 |
| | | | crystal (fcc), | | |
| | | | Si: amorphous | | |
| | | | structure | | |
| Example 7 | 40Ag—60Ge | 10 | Ag: columnar | Ru | 3.2 |
| | | | crystal (fcc), | | |
| | | | Ge: amorphous | | |
| | | | structure | | |
| Example 8 | 40Ag—60Ge | 5 | Ag: columnar | Ru | 3.8 |
| | | | crystal (fcc), | | |
| | | | Ge: amorphous | | |
| | | | structure | | |
| Example 9 | 40Ag—60Ge | 10 | Ag: columnar | Ru | 3.3 |
| | | | crystal (fcc), | | |
| | | | Ge: amorphous | | |
| | | | structure | | |
| Example 10 | 40Ag—60Ge | 10 | Ag: columnar | Ru | 3.3 |
| | | | crystal (fcc), | | |
| | | | Ge: amorphous | | |
| | | | structure | | |
| Example 11 | 40Ag—60Ge | 10 | Ag: columnar | Ru | 3.5 |
| | | | crystal (fcc), | | |
| | | | Ge: amorphous | | |
| | | | structure | | |

TABLE 2-2

| | Seed layer | | | Intermediate | |
|---|---|---|---|---|---|
| | | Thick- | | layer | |
| | Composition | ness | | Compo- | |
| | [atomic %] | [nm] | Structure | sition | Δθ50 |
| Comparative | 40Ag—60Ge | 5 | Ag: columnar | Ru | >6.0 |
| Example 1 | | | crystal (fcc), | | |
| | | | Ge: amorphous | | |
| | | | structure | | |
| Comparative | 40Ag—60Ge | 5 | Ag: columnar | Ru | 4.2 |
| Example 2 | | | crystal (fcc), | | |
| | | | Ge: amorphous | | |
| | | | structure | | |
| Comparative | 40Ag—60Ge | 5 | Ag: columnar | Ru | 4.5 |
| Example 3 | | | crystal (fcc), | | |
| | | | Ge: amorphous | | |
| | | | structure | | |
| Comparative | 40Ag—60Ge | 5 | Ag: columnar | Ru | >6.0 |
| Example 4 | | | crystal (fcc), | | |
| | | | Ge: amorphous | | |
| | | | structure | | |
| Comparative | 40Ag—60Ge | 5 | Ag: colunnar | Ru | 4.2 |
| Example 5 | | | crystal (fcc), | | |
| | | | Ge: amorphous | | |
| | | | structure | | |
| Comparative | 40Ag—60Ge | 5 | Ag: columnar | Ru | >6.0 |
| Example 6 | | | crystal (fcc), | | |
| | | | Ge: amorphous | | |
| | | | structure | | |
| Comparative | 50Ag—50Si | 10 | Ag: columnar | MgO | >6.0 |
| Example 7 | | | crystal (fcc), | | |
| | | | Si: amorphous | | |
| | | | structure | | |

TABLE 3-1

Magnetic particles of
magnetic recording layer

| | Composition | D [nm] | σ/D [%] |
|---|---|---|---|
| Example 1 | CoCrPt-based alloy | 6.8 | 13 |
| Example 2 | CoCrPt-based alloy | 6.3 | 14 |
| Example 3 | CoCrPt-based alloy | 8.1 | 15 |
| Example 4 | CoCrPt-based alloy | 8.2 | 15 |
| Example 5 | CoCrPt-based alloy | 7.4 | 14 |
| Example 6 | FePt | 6.3 | 15 |
| Example 7 | CoCrPt-based alloy | 6.8 | 13 |
| Example 8 | CoCrPt-based alloy | 6.3 | 13 |
| Example 9 | CoCrPt-based alloy | 6.8 | 14 |
| Example 10 | CoCrPt-based alloy | 6.8 | 14 |
| Example 11 | CoCrPt-based alloy | 6.8 | 14 |

TABLE 3-2

Magnetic particles of
magnetic recording layer

| | Composition | D [nm] | σ/D [%] |
|---|---|---|---|
| Comparative | CoCrPt-based alloy | 6.8 | 19 |
| Example 1 | | | |
| Comparative | CoCrPt-based alloy | 6.5 | 21 |
| Example 2 | | | |
| Comparative | CoCrPt-based alloy | 7.0 | 16 |
| Example 3 | | | |
| Comparative | CoCrPt-based alloy | 7.1 | 20 |
| Example 4 | | | |
| Comparative | CoCrPt-based alloy | 7.0 | 22 |
| Example 5 | | | |
| Comparative | CoCrPt-based alloy | 6.8 | 18 |
| Example 6 | | | |
| Comparative | FePt | 7.2 | 22 |
| Example 7 | | | |

As shown in Tables 2-1 and 2-2 and Tables 3-1 and 3-2, in the Examples, the c-axis orientation dispersion Δθ50 of the intermediate layer was 5.1 or less, the average particle size D of the magnetic particles of the magnetic recording layer was 8.2 nm or less, and the particle size dispersion σ/D was 15% or less, which were all relatively low values. Conversely, in the Comparative Examples, the c-axis orientation dispersion Δθ50 of the intermediate layer was 4.2 or more and the particle size dispersion σ/D of the magnetic recording layer was 16 or more, which were both relatively high values.

It was confirmed based on the results that the magnetic particles included in the magnetic recording layer were micronized and the perpendicular orientation was enhanced when the seed layer of the magnetic recording medium included two elements, the phase of one element of which having a columnar crystal having an fcc structure and the phase of the other element having an amorphous structure, and the first base layer mainly included Ru, Cr, or Ni, the second base layer mainly included the one element, and the third base layer mainly included Ru, Cr, or Mo. This suggests that the magnetic recording medium of each Example includes a magnetic recording layer having an increased recording density. Thus, the magnetic recording and reproducing device including the magnetic recording medium of each Example can have an increased recording capacity.

The present disclosure enhances the perpendicular orientation of the magnetic recording layer, enabling an increased recording density.

What is claimed is:

1. A magnetic recording medium, comprising:
a nonmagnetic substrate;
a base layer over the nonmagnetic substrate;
a seed layer over the base layer; and
a magnetic recording layer over the seed layer, wherein
the seed layer includes two elements that are phase-separated from each other,
a phase of one element of the two elements, represented by element α, mainly includes a columnar crystal having an fcc structure,
a phase of another element of the two elements, represented by element β, mainly includes an amorphous structure,
the base layer includes, in sequence from the nonmagnetic substrate, a first base layer, a second base layer, and a third base layer,
the first base layer mainly includes Ru, Cr, or Ni,
the second base layer mainly includes the element α, and
the third base layer mainly includes Ru, Cr, or Mo.

2. The magnetic recording medium according to claim 1, wherein
the element α is Ag, Au, Al, or Pd, and
the element β is Ge or Si.

3. The magnetic recording medium according to claim 1, further comprising:
an intermediate layer between the seed layer and the magnetic recording layer, wherein
the intermediate layer is a layer that mainly includes Ru, and
the magnetic recording layer is a layer that mainly includes Co, Cr, and Pt.

4. The magnetic recording medium according to claim 1, further comprising:
an intermediate layer between the seed layer and the magnetic recording layer, wherein
the intermediate layer is a layer that mainly includes an NaCl-type compound, and
the magnetic recording layer is a layer that mainly includes a magnetic particle having an L1₀ structure.

5. A magnetic recording and reproducing device, comprising:
the magnetic recording medium of claim 1.
